(19) United States
(12) Patent Application Publication
(10) Pub. No.: US 2012/0232965 A1
(43) Pub. Date: Sep. 13, 2012

(54) INTERACTIVE VALET PARKING MANAGEMENT SYSTEM

(75) Inventors: Juan F. Rodriguez, Austin, TX (US); Eliseo J. Diaz, Austin, TX (US); Dean A. Cleaver, Austin, TX (US)

(73) Assignee: KLEVER LOGIC, INC., Austin, TX (US)

(21) Appl. No.: 13/415,750

(22) Filed: Mar. 8, 2012

Related U.S. Application Data
(60) Provisional application No. 61/451,529, filed on Mar. 10, 2011.

(51) Int. Cl. G07B 15/00

(52) U.S. Cl. 705/13

(57) ABSTRACT

One example embodiment includes a system which allows a user to obtain valet services. The system includes an incoming interaction pre-processor. The incoming interaction pre-processor is configured to receive an incoming interaction and determine the type of interaction. The system also includes a processing system, where the processing system provides the interactions to the proper provider. The system further includes a provider management module, where the provider management module is configured to allow each provider to modify desired parameters.

### CROSS-REFERENCE TO RELATED APPLICATIONS

This application claims the benefit of and priority to U.S. Provisional Patent Application Ser. No. 61/451,529 filed on Mar. 10, 2011, which application is incorporated herein by reference in its entirety.

### BACKGROUND OF THE INVENTION

Valet parking can provide great convenience to a user. For disabled users, it can save the user from having to walk long distances from the parking lot to the entrance or vice versa. Additionally, it can allow the user to avoid the elements when desired, such as cold, windy or wet days. Further it can save the user from taking valuable time to look for parking spots. For users that are late or otherwise in a hurry, this can be an invaluable service.

Currently, the majority of interactions with a valet service are in person. I.e., the user waits in line and physically hands his/her valet parking ticket to the valet parking provider. In many cases, this can eliminate the convenience of valet parking. Some services allow the user to call a number and have an attendant answer. Usually, this service is available in parking garages, office buildings, condominiums, hotels and the like.

Accordingly, there is a need in the art that allows a user to interact via smart phone or text message with a valet service.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system which allows a user to obtain valet services. The system includes an incoming interaction pre-processor. The incoming interaction pre-processor is configured to receive an incoming interaction and determine the type of interaction. The system also includes a processing system, where the processing system provides the interactions to the proper provider. The system further includes a provider management module, where the provider management module is configured to allow each provider to modify desired parameters.

Another example embodiment includes a system which allows a user to obtain valet services. The system includes an incoming interaction pre-processor. The incoming interaction pre-processor is configured to receive an incoming interaction and determine the type of interaction. The system also includes a processing system. The processing system is configured to store interaction rules for each provider and provide the interactions to the proper provider. The system further includes a provider management module, where the provider management module is configured to allow each provider to modify desired parameters.

Another example embodiment includes a system which allows a user to obtain valet services. The system includes an incoming interaction pre-processor. The incoming interaction pre-processor is configured to receive an incoming interaction, where the incoming interaction is received from a customer. The incoming interaction pre-processor is also configured to determine the type of interaction, where determining the type interaction includes determining the services requested by the user. The system also includes a processing system. The processing system is configured to store interaction rules for each provider and determine a proper provider to provide the service to the user. The processing system is also configured to provide at least a portion the request to the proper provider and withhold at least a portion of the request from the proper provider. The system further includes a provider management module, where the provider management module is configured to store parameters for each provider and allow each provider to modify the stored parameters.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a block diagram illustrating an example of a system for interactive valet management;

FIG. 2 illustrates an example of a system for interactive valet management;

FIG. 3 illustrates an example of a user interface for use with an interactive valet management system;

FIG. 4 illustrates an example of a valet interface for use with an interactive valet management system; and

FIG. 5 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

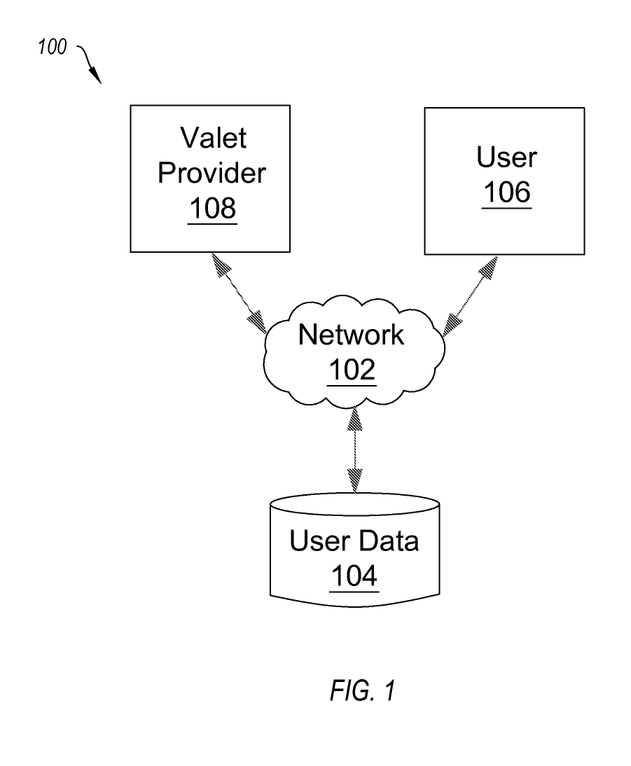

FIG. 1 is a block diagram illustrating an example of a system 100 for interactive valet management. In at least one implementation, the system 100 can be used to allow valet parking customers to request their vehicles utilizing a mobile device. The mobile device (cell phone, smart phone, tablet, laptop/computer, app phone) can interact with a system via Short Message System (SMS) utilizing a short code or long code, Unstructured Supplementary Service Data (USSD), Smart Phone App (Android, iPhone, Blackberry, J2ME, Windows Mobile), Interactive Voice Response (IVR), Instant Messaging Platforms (Google Talk, AIM, Yahoo, MSN, Jabber), Messaging Platform (email, twitter, Facebook) or push notifications. Valet parking providers receive customer requests on their mobile device or computer and are able to interact back and forth with the customer.

One of skill in the art will appreciate that although the system 100 is exemplarily used for valet parking, the system 100 can be used for other purposes. For example, the system 100 can be used to request a boat be released onto the water from the boat dock or lift: order food from restaurant, hotel, stadium or other area; request to be added to a restaurant's waiting list; request a bell boy at a hotel; request a taxi; request an airport shuttle; request concierge services; reserve a salon/barber/spa/nail shop appointment; book a massage; book a golf tee time; or use any service-based business where people wait in line or on hold on the phone for certain tasks such as: requests, orders or to schedule services. In particular, the system 100 can be used for any desired purpose without restriction unless otherwise specified in the claims.

FIG. 1 shows that the system 100 can include a network 102. In at least one implementation, the network 102 can be used to connect the various parts of the system 100 to one another. The network 102 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 102 includes one or more cellular RF networks and/or one or more wired and/or wireless networks such as, but not limited to, 802.xx networks, Bluetooth access points, wireless access points, IP-based networks, or the like. For example, the network 102 can include cloud based networking and computing. The network 102 can also include servers that enable one type of network to interface with another type of network.

FIG. 1 also shows that the system 100 can include user database 104. In at least one implementation, the user database 104 can include any system capable of storing and retrieving the desired data files. For example, the user database 104 can include an electronic database capable of electronically storing data. E.g., the user database 104 can include memory or memory banks. Additionally or alternatively, the user database 104 can include processors or other logic devices capable of executing software or carrying out other computer algorithms. The user database 104 can allow a user to access the hardware of the user database 104 for remote computing or for information retrieval.

FIG. 1 further shows that the system 100 can include a user 106. In at least one implementation, the user 106 can include any individual, business, organization or other entity which uses the system 100. For example, the user 106 can include an individual that has parked his/her car using a valet service. Additionally or alternatively, the user 106 can include a company that is tracking one or more vehicles using a valet service. The user 106 can access his/her user information in the user database 104 over the network 102.

FIG. 1 additionally shows that the system 100 can include a valet provider 108. In at least one implementation, the valet provider 108 can include an organization that provides a valet service. In particular, the valet provider 108 can receive a vehicle at a designated location from a user 106 then park the vehicle. The user 106, or a different individual, may later contact the valet provider 108 who retrieves the vehicle and returns it to either the area where it was initially received or at another designated location. The valet provider 108 may provide additional services while in possession of the vehicle, such as cleaning or detailing either the interior and/or the exterior of the vehicle.

In at least one implementation, the valet provider 108 records information about the vehicle in the user database 104 over the network 102. The information can then be retrieved as needed by either the user 106 or the valet provider 108 from the user database 104 over the network 102. The information can include any desired information. For example, the information can include time information, such as when the vehicle was left with the valet provider 108, can include care information, such as what services were requested by the user 106 and/or performed by the valet provider 108 or can include any other desired information. Additionally or alternatively, the information can include requests made by the user 106 such as cleaning, detailing, vehicle retrieval, cost information, payment information (including but not limited to Credit Card, PayPal, Google Checkout, Close-Loop Valet Parking Account and Bill to Mobile Phone Carrier) or any other desired user request.

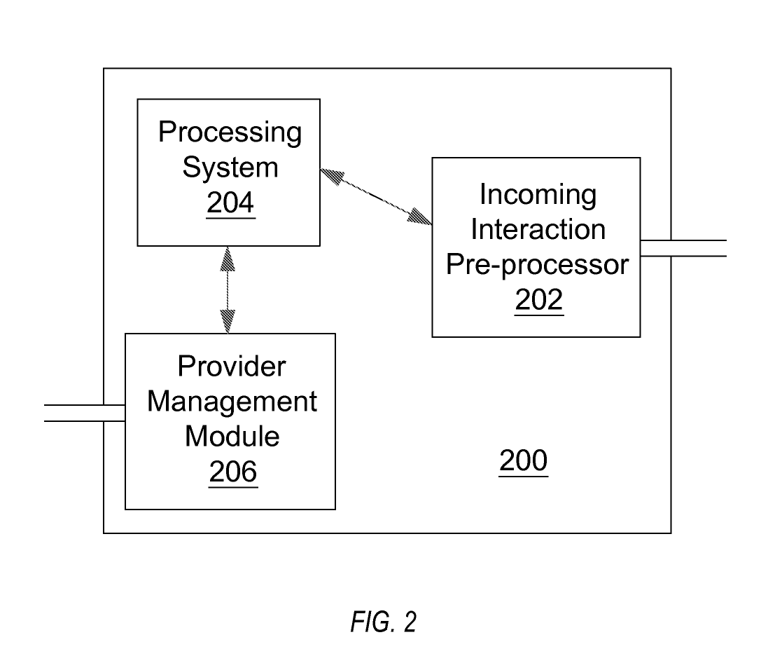

FIG. 2 illustrates an example of a system 200 for interactive valet management. In at least one implementation, the system 200 can allow a user to request valet services remotely. Additionally or alternatively, the system 300 can allow a valet provider to monitor customer service and coordinate activities of various employees. One of skill in the art will appreciate that the system 200 can be cloud based. I.e., cloud computing is the delivery of computing as a service rather than a product, whereby shared resources, software, and information are provided to computers and other devices as a utility. Cloud computing can provide computation, software applications, data access, data management and storage resources without requiring cloud users to know the location and other details of the computing infrastructure. For example, end users can access cloud based applications through a web browser or a light weight desktop or mobile app while the business software and data are stored on servers at a remote location. Cloud application providers strive to give the same or better service and performance as if the software programs were installed locally on end-user computers.

FIG. 2 shows that the system 200 can include an incoming interaction pre-processor 202. In at least one implementation, the incoming interaction pre-processor 202 can receive all the initial incoming interactions from a user and the valet service and determine the type of interaction. For example, the interactions can include: an initial request, a timed out request, a cancellation request, a ticket color request question or order. If the interaction isn't properly formatted or the data validation is not understood by the incoming interaction pre-processor 202 it can automatically respond back to the user and provide an error or instructions to the user so the interaction can be re-initiated.

FIG. 2 also shows that the system 200 can include a processing system 204. In at least one implementation, the processing system 204 can include perspective business rules of the interaction type. I.e., the processing system 204 can determine the proper action to take based on the interaction initiated by the user as determined by the incoming interaction pre-processor 202. Additionally or alternatively, the processing system 204 can queue-up customer interactions from the incoming interaction pre-processor 202 to be delivered to the proper provider, as described below. The processing system 204 can include database schemas, a business logic layer, an application programming interface (API) layer and any other desired components.

In at least one implementation, the processing system 204 can initiate communication between the user and the valet service. For example, the processing system can lets the user know that the car is actually outside waiting via SMS, push notification or TCP-IP socket, can invoke an IVR to make a phone call which speaks a message to the user informing them that the vehicle is outside, or can invoke an IVR to call the valet's phone and the user's phone and provides a conference between them, so the valet attendant can communicate with the user while maintaining customer mobile device confidentiality.

Additionally or alternatively, the processing system 204 can provide information about services. For example, the processing system 204 can estimate a car arrival time. I.e., the system will calculate the car delivery time based on factors such as previous history for that day of the week, special event occurrence, current time and the number of valet runners on duty. The processing system 204 can also allow the valet service to override the automatic time calculation. E.g., the valet attendant can choose the number of minutes it would take to deliver the vehicle. The customer then receives proper notification of the estimated time of arrival of their vehicle.

Additionally or alternatively, the processing system 204 can store all interactions on the system. For example, the queue of requests can be constantly updated. This ensures that the 1st person to request the vehicle is the first person to get their vehicle. If desired by the provider, some VIP customers will have a different treatment within the queue and would jump to the top of the queue. Further, the processing system 204 can allow providers to block or black-list mobile numbers, device ID's, IM ID's or messaging platform ID's to ensure that specific customers are not allowed to use the service. In addition, the processing system 204 can create business intelligence reports. I.e., every detail of each interaction at a granular level can be stored on the system database. This data can later be used to provide extensive reporting capabilities on usage, provider performance and unlimited key performance indicators (KPI's).

Additionally or alternatively, the processing system 204 can includes an incoming message analyzer. In at least on implementation, every interaction commenced by a customer needs to be analyzed to ensure that the request makes sense to the provider. Ex #1: customer sends this text message in; “Please get my car, my ticket# is 123-456, I'm coming out in 2 minutes”. The system runs algorithms to automatically omit the data that is not relevant and sends to the providers only “123456”. Ex #2: customer sends this text message in; “please get my car, blue ford”. The system runs algorithms and automatically determines that this incoming message does not have sufficient information to process the action. At this point the system replies back to the customer providing the customer with clear instructions on how to properly request.

FIG. 2 further shows that the system 200 can include a provider management module 206. In at least one implementation, the provider management module 206 can allow the valet provider to customize services. For example, the provider management module 206 can allow the valet provider to add/delete/block/suspend/modify: locations; valet fees; employees; employees pay rate; system roles; reports; accounting data; dashboard; block/black list particular users or employees; customizes business rules, such as: change messages and IVR messages, activate a fee for each interaction time and setup interaction type, workflow, and advertisement workflow; or any other desired functionality.

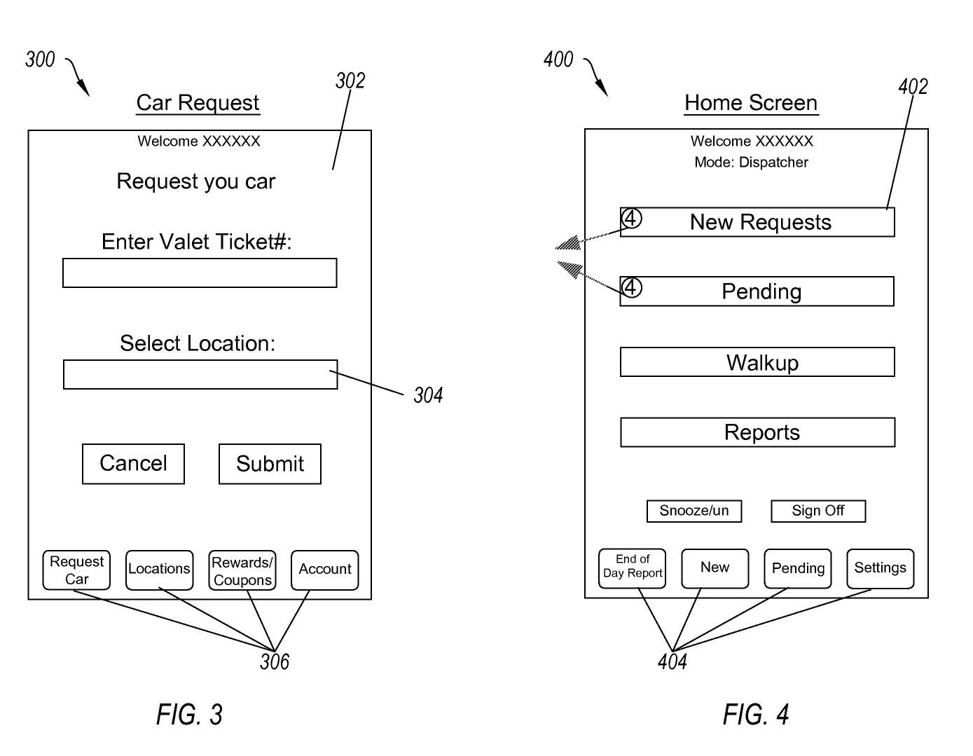

FIG. 3 illustrates an example of a user interface 300 for use with an interactive valet management system. In at least one implementation, the user interface 300 can allow the user to view, hear or otherwise interact with the valet service. In particular, the user interface 300 can allow the user to directly input or receive data into an interactive valet management system. One of skill in the art will appreciate that different user interfaces may be provided to allow users to interact with the interactive valet management system in a preferred manner. For example, the user can use a browser, app, program, voice commands, text messaging, email or any other interface. The user interface 300 can include a graphical user interface, controls, speakers, displays or any other necessary hardware and/or software to adequately display desired information to the user, as described below.

In at least one implementation, a graphical user interface (“GUI” sometimes pronounced gooey) is a type of user interface 300 that allows users to interact with electronic devices with images rather than text commands. GUIs can be used in computers, hand-held devices such as MP3 players, portable media file players or gaming devices, cell phones, tablets, household appliances, office equipment and any other desired device. A GUI represents the information and actions available to a user through graphical icons and visual indicators such as secondary notation, as opposed to text-based interfaces, typed command labels or text navigation. The actions are usually performed through direct manipulation of the graphical elements.

FIG. 3 shows that the user interface 300 can include a request 302. In at least one implementation, the request 302 can allow the user to input desired data and/or request a specific service. For example, the user can use the request 302 to request his/her car, select a pick-up or drop-off location, request cleaning or detailing, request price information, make payments, authorize pick-up by other drivers, redeem coupons or customer incentives, change users or any other desired service. The request 302 may be for immediate service or to schedule future service. For example, the request 302 can allow the user to schedule a pick-up or drop-off at a future time.

FIG. 3 also shows that the user interface 300 can include an input 304. In at least one implementation, the input 304 can allow the user to enter appropriate data. For example, the input 304 can allow the user to enter a desired location to find the nearest valet provider. Additionally or alternatively, the input 304 can allow the user to enter payment information, identifying information, coupon or reward numbers or any other appropriate information. The input 304 may allow the user to select from predetermined options or allow the user to enter free form text.

In at least one implementation, the input 304 can be done automatically. For example, the user may request pick-up at his/her current location which may or may not be the same location where the vehicle was dropped off for valet services. The input 304 can the request the required information from other programs on the device being used by the user. E.g., the input 304 can retrieve location information from a GPS service and time information from a clock service then add the information to the input 304.

FIG. 3 further shows that the user interface 300 can include options 306. In at least one implementation, the options 306 can allow the user to perform specific tasks or set specific options. For example, the user can store a credit card number for future payment options, set user preferences, make specific requests, redeem coupons, rewards/loyalty program or other incentives or take other desired actions.

In at least one implementation, the options 306 can allow the user to pre-enter or save information. For example, the user can enter the name of the primary driver; additional driver's full names; vehicle: make, model, color, license plate; additional vehicles the customer wishes to register; photographs of: drivers' faces, vehicles, keys, car registration documents; or other desired information. The pre-entered information may allow the user to make valet interactions more timely. For example, the options 306 can allow “ticketless” valet parking. When the customer arrives at the valet parking location, the valet parking provider will be notified using GPS and triangulation that this particular customer utilizes the “ticketless” feature and will be given the make, model, color and license plate number of their vehicle. Additionally or alternatively, the valet parking provider can use BUMP Technologies, Inc., or a similar server, to push a virtual ticket. Furthermore, the valet parking provider can utilize the smartphone app to push a virtual ticket to the valet parking customer. When the customer exits the venue, he/she can request their car from their mobile device. Essentially, the ticket number is virtually stored on the system. No physical valet parking ticket is necessary. Furthermore, “ticketless” valet can be achieved by asking the valet parking customer for a credit card or driver's license and swiping or scanning it on an appropriate device. For example, a mobile device barcode reader can be used to read a vehicle VIN# as well as read driver's license data. Additionally or alternatively, a mag-stripe reader can be used to read credit card and driver's license mag-stripe data to create a ticketless valet process. I.e., the data from the mag-stripe can be used to validate the valet parking customer.

FIG. 4 illustrates an example of a valet interface 400 for use with an interactive valet management system. In at least one implementation, the valet interface 400 can allow the valet service to view, hear or otherwise interact with the user. In particular, the valet interface 400 can allow the valet service to directly input or receive data from an interactive valet management system. One of skill in the art will appreciate that different valet interfaces may be provided to allow specific individuals to interact with the valet management system according to their needs. For example, the valet service can use a browser, app, program, voice commands, text messaging, email or any other interface. The valet interface 400 can include a graphical user interface, controls, speakers, displays or any other necessary hardware and/or software to adequately display the desired information to the valet service, as described below.

In at least one implementation, the interactive valet management system 400 can shield some of the user's information. In particular, the interactive valet management system can allow some information to be passed to the valet service and can withhold other information from being passed to the valet service. For example, the interactive valet management system can protect the user's name, payment information, contact information, method of interaction or any other desired information.

FIG. 4 shows that the valet interface 400 can include a request 402. In at least one implementation, the request 402 can allow the valet service to input desired data and/or enter a specific service. For example, the valet service can use the request 402 to show that the user selected his/her car, select a pick-up or drop-off location, confirm cleaning or detailing, confirm price information, receive payments, allow authorization of pick-up by other drivers, provide coupons or customer incentives or any other desired service.

In at least one implementation, the request 402 can allow individuals associated with the valet service to communicate with one another. For example, the request 402 can allow dispatchers or valets to broadcast messages between each other as a means of communication. The geographical or personnel limitations of the messages can be configured to inform only those who need the information.

Additionally or alternatively, the request 402 can inform the valet service about an incoming message. For example, if a dispatcher or attendant happens to be on a phone call and a request comes into the system, the system will not disconnect the call. However it will notify the valet of the pending request by an audible tone sounded through the headset speaker. This will ensure that the valet is notified of the request in a timely manner.

Additionally or alternatively, the request 402 can include a request for a vehicle from a user. The request may allow the valet service to provide an appropriate response to the user. For example, the valet service may accept the request—this will notify the user of the estimated arrival time; report as invalid—the user is notified that the ticket# submitted does not correspond to a car on the valet parking lot; or request color of the ticket—notifies the customer to please respond with the color of the valet ticket.

In at least one implementation, the valet interface 400 can include an input. In at least one implementation, the input can allow the valet service to enter appropriate data. For example, the input can allow the valet service to enter a time that the vehicle was received from an individual. Additionally or alternatively, the input can allow the valet service to enter payment information, produce a valet ticket, allow an individual to redeem a coupon or reward numbers or any other appropriate information. The input may allow the valet service to select from predetermined options or allow the valet service to enter free form text.

Additionally or alternatively, the input can be stored remotely for automatic input. For example, the data collected pertinent to each valet parking transaction can include: valet ticket #, customer name, driver's license #, make, model, color, cars license plate, date/time parked, date/time retrieved, who parked it, location parked and who retrieved it. Additionally, the input can include visual data. For example, the input can include the camera on the mobile device to take pictures of the vehicles damages to avoid false claims.

Additionally or alternatively, the input can allow the valet to enter login information. In at least one implementation, the login information can allow an attendant or dispatcher to log into a specific location/shift. The system then automatically routes car retrieval requests to the appropriate logged in attendant. For example, the input can include: employee name, clock-in time, clock-out time, GPS location of the action, driver's license data of mag-stripe or 2D data and face/biometric recognition.

FIG. 4 further shows that the valet interface 400 can include options 404. In at least one implementation, the options 404 can allow the valet service to perform specific tasks or set specific options. For example, the valet service can allow different users to engage in different tasks or to view different information. For example, a manager may be able to enter payment information, whereas other employees may be able to check in customers. Alternatively, a manager or dispatcher may be able to see multiple requests in order to see the entire queue, whereas a valet may be provided with his/her next task only.

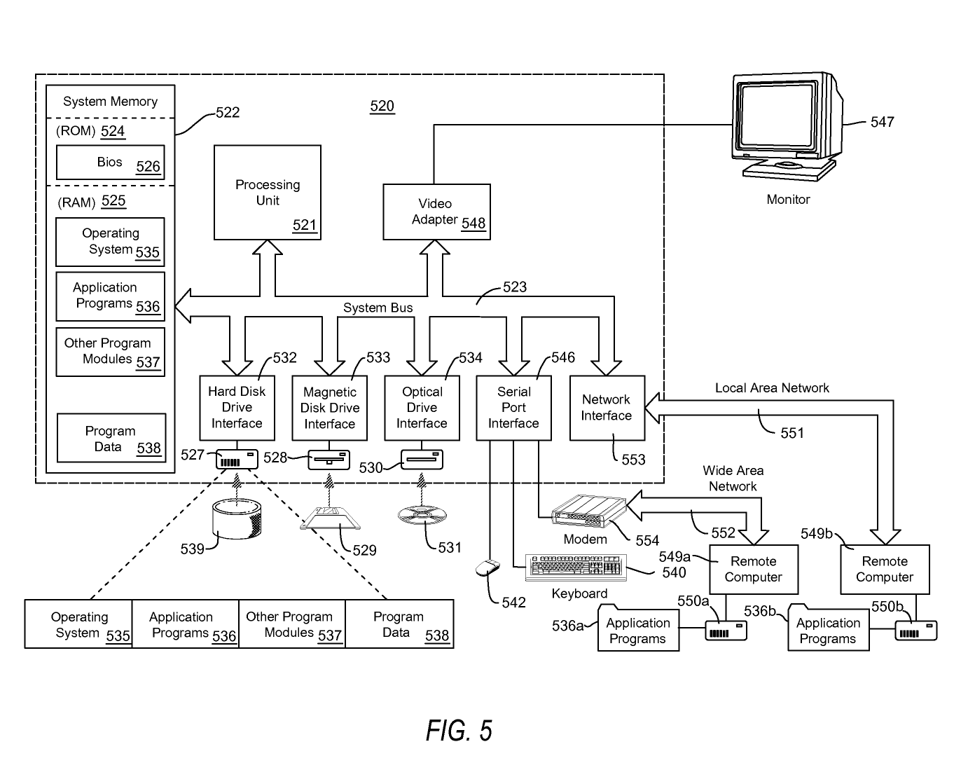

FIG. 5, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 5, an example system for implementing the invention includes a general purpose computing device in the form of a conventional computer 520, including a processing unit 521, a system memory 522, and a system bus 523 that couples various system components including the system memory 522 to the processing unit 521. It should be noted however, that as mobile phones become more sophisticated, mobile phones are beginning to incorporate many of the components illustrated for conventional computer 520. Accordingly, with relatively minor adjustments, mostly with respect to input/output devices, the description of conventional computer 520 applies equally to mobile phones. The system bus 523 may be any of several types of bus structures including a memory bus or memory controller, a peripheral bus, and a local bus using any of a variety of bus architectures. The system memory includes read only memory (ROM) 524 and random access memory (RAM) 525. A basic input/output system (BIOS) 526, containing the basic routines that help transfer information between elements within the computer 520, such as during start-up, may be stored in ROM 524.

The computer 520 may also include a magnetic hard disk drive 527 for reading from and writing to a magnetic hard disk 539, a magnetic disk drive 528 for reading from or writing to a removable magnetic disk 529, and an optical disc drive 530 for reading from or writing to removable optical disc 531 such as a CD-ROM or other optical media. The magnetic hard disk drive 527, magnetic disk drive 528, and optical disc drive 530 are connected to the system bus 523 by a hard disk drive interface 532, a magnetic disk drive-interface 533, and an optical drive interface 534, respectively. The drives and their associated computer-readable media provide nonvolatile storage of computer-executable instructions, data structures, program modules and other data for the computer 520. Although the exemplary environment described herein employs a magnetic hard disk 539, a removable magnetic disk 529 and a removable optical disc 531, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 539, magnetic disk 529, optical disc 531, ROM 524 or RAM 525, including an operating system 535, one or more application programs 536, other program modules 537, and program data 538. A user may enter commands and information into the computer 520 through keyboard 540, pointing device 542, or other input devices (not shown), such as a microphone, joy stick, game pad, satellite dish, scanner, motion detectors or the like. These and other input devices are often connected to the processing unit 521 through a serial port interface 546 coupled to system bus 523. Alternatively, the input devices may be connected by other interfaces, such as a parallel port, a game port or a universal serial bus (USB). A monitor 547 or another display device is also connected to system bus 523 via an interface, such as video adapter 548. In addition to the monitor, personal computers typically include other peripheral output devices (not shown), such as speakers and printers.

The computer 520 may operate in a networked environment using logical connections to one or more remote computers, such as remote computers 549a and 549b. Remote computers 549a and 549b may each be another personal computer, a server, a router, a network PC, a peer device or other common network node, and typically include many or all of the elements described above relative to the computer 520, although only memory storage devices 550a and 550b and their associated application programs 536a and 536b have been illustrated in FIG. 5. The logical connections depicted in FIG. 5 include a local area network (LAN) 551 and a wide area network (WAN) 552 that are presented here by way of example and not limitation. Such networking environments are commonplace in office-wide or enterprise-wide computer networks, intranets and the Internet.

When used in a LAN networking environment, the computer 520 can be connected to the local network 551 through a network interface or adapter 553. When used in a WAN networking environment, the computer 520 may include a modem 554, a wireless link, or other means for establishing communications over the wide area network 552, such as the Internet. The modem 554, which may be internal or external, is connected to the system bus 523 via the serial port interface 546. In a networked environment, program modules depicted relative to the computer 520, or portions thereof, may be stored in the remote memory storage device. It will be appreciated that the network connections shown are exemplary and other means of establishing communications over wide area network 552 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system which allows a user obtain valet services, the system comprising:
an incoming interaction pre-processor, wherein the incoming interaction pre-processor is configured to:
receive an incoming interaction; and
determine the type of interaction;
a processing system, wherein the processing system provides the interactions to the proper provider; and
a provider management module, wherein the provider management module is configured to allow each provider to modify desired parameters.

2. The system of claim 1, wherein the processing system includes a logic device.

3. The system of claim 2, wherein the logic device includes a processor.

4. The system of claim 1, wherein the incoming type of incoming interaction includes a pick-up, wherein the pick-up includes the valet service taking possession of a vehicle.

5. The system of claim 1, wherein the incoming type of interaction includes a vehicle return, wherein the vehicle return includes returning possession of a vehicle to a customer.

6. The system of claim 1, wherein the processing system withholds at least one piece of information from the provider.

7. The system of claim 6, wherein the at least one piece of information includes payment information.

8. The system of claim 1, wherein the desired parameter includes cost information.

9. The system of claim 1, wherein the desired parameters include locations.

10. The system of claim 1, wherein the desired parameters include hours of operation.

11. A system for allowing a user to interact with a valet service, the system comprising:
an incoming interaction pre-processor, wherein the incoming interaction pre-processor is configured to:
receive an incoming interaction; and
determine the type of interaction;
a processing system, wherein the processing system is configured to:
stores interaction rules for each provider; and
provides the interactions to the proper provider; and
a provider management module, wherein the provider management module is configured to allow each provider to modify desired parameters.

12. The system of claim 11, wherein the an incoming interaction pre-processor is further configured to provide a response to a user that sent an incoming interaction.

13. The system of claim 12, wherein the response includes an SMS message.

14. The system of claim 12, wherein the response includes a push notification.

15. The system of claim 12, wherein the response invoking an interactive voice recording.

16. The system of claim 12, wherein the response includes an error message.

17. The system of claim 12, wherein the response includes a confirmation of services.

18. A system for allowing a user to interact with a valet service, the system comprising:
an incoming interaction pre-processor, wherein the incoming interaction pre-processor is configured to:
receive an incoming interaction, wherein the incoming interaction is received from a customer; and
determine the type of interaction, wherein determining the type interaction includes determining the services requested by the user;
a processing system, wherein the processing system is configured to:
store interaction rules for each provider; and
determine a proper provider to provide the service to the user;
provide at least a portion of the request to the proper provider; and
withhold at least a portion of the request from the proper provider; and
a provider management module, wherein the provider management module is configured to:
store parameters for each provider; and
allow each provider to modify the stored parameters.

19. The system of claim 18, wherein the interaction includes an interaction received from a smartphone app.

20. The system of claim 18, wherein the stored parameters include at least one of:
locations;
valet fees;
employees;
employee pay rates;
system role;
reports;
accounting data;
dashboard;
block/black list; or
customized business rules.
